(19) United States
(12) Patent Application Publication
(10) Pub. No.: US 2015/0327450 A1
(43) Pub. Date: Nov. 19, 2015

(54) IRRIGATION SYSTEM HAVING VARIABLE DATA TRANSMISSION INTERVALS, DATA TRANSMISSION SYSTEM FOR IRRIGATION SYSTEM AND METHOD OF PERFORMING DATA TRANSMISSION FOR SAME

(71) Applicant: Hortau Inc., St-Romuald (CA)

(72) Inventors: Jocelyn Boudreau, Saint-Lambert-de-Lauzon (CA); Sebastien Rochette, Quebec (CA); Dave Gagnon, Beaumont (CA); Philippe Saucier, Levis (CA)

(21) Appl. No.: 14/712,475

(22) Filed: May 14, 2015

Related U.S. Application Data
(60) Provisional application No. 61/993,085, filed on May 14, 2014.

(51) Int. Cl. A01G 25/16; G05B 15/02

(52) U.S. Cl. CPC A01G 25/16; G05B 15/02

(57) ABSTRACT

A data transmission system for an irrigation system which comprises at least one field sensor collecting field data, at least one field monitoring station in communications with the at least one field sensor and a control unit in communications with the at least one field monitoring station over a remote communications link. The field data collected using the at least one field sensor is transmitted to the at least one field monitoring station. The field data is transmitted from the at least one field monitoring station to the control unit at a field data transmission interval adjusted according to a likelihood of an upcoming irrigation need determined based on the field data collected by the at least one field sensor and the control unit generates irrigation instructions based on the field data. An automated irrigation system and a method of performing data transmission for an irrigation system are also provided.

### CROSS REFERENCE TO RELATED APPLICATION

This application claims the benefit under 35 U.S.C. §119(e) of U.S. provisional patent application No. 61/993,085 which was filed on May 14, 2014. The entirety of the aforementioned application is herein incorporated by reference.

### FIELD OF THE INVENTION

The present invention relates to the field of automated irrigation systems. More particularly, it relates to an automated irrigation system configured to vary intervals of functional data transfer between components thereof. The present invention also relates to a data transmission system for an irrigation system and a method of performing data transmission for same.

### BACKGROUND

Automated irrigation systems are known in the art to assist agricultural producers with irrigation tasks, in order to optimize crop production, for example by reducing plant water stress. Automated irrigation systems usually rely on data indicative of plant water needs, such as, for example, soil tension, soil salinity, weather data, or the like. For example, the data can be gathered by dedicated field sensors located directly in the field, and transmitted to a control system operative to receive the data and control the irrigation equipment based on the data received from the field sensors and additional irrigation parameters.

It will be easily understood that, given the remote location of several agricultural facilities and the large area that they cover, power consumption of specific components of the system is often a critical factor. This is especially the case for components which must rely on limited power sources, such as, for example battery power, solar panels or the like. Therefore, in many cases, specific components of the system are configured to operate in low power consumption modes for predetermined time periods, in order to reduce their overall power consumption. Different types and configurations of low power consumption modes can be implemented. For example and without being limitative, communications resources of the component can be turned off, thereby preventing data communications to and/or from the component for a predetermined time period, the time period between intervals of data transmission being increased, for example, when power resources are low, or the like.

Known automated irrigation systems however tend to suffer from several drawbacks. For example, interruption of data communications between the components in the above described low power mode can result in delay of operation of the irrigation system, i.e. between the time when a command for a change in the irrigation process is issued and the time when the change is initiated. Moreover, unadapted data transmission intervals can result in unnecessary power consumption or undesirable delay in performance of irrigation instructions. Indeed, for example, unnecessary power can be used to transmit data gathered from the field sensors between the components during time periods where the collected data is indicative that the likelihood of an upcoming need of irrigation is low or intervals of data transmission can be too long to allow a sufficiently prompt irrigation reaction in time periods where the collected data is indicative that the likelihood of an upcoming need of irrigation is high.

In view of the above, there is a need for an improved automated irrigation system, data transmission system for an irrigation system and method of operation thereof which would be able to overcome or at least minimize some of the above-discussed prior art concerns.

### SUMMARY OF THE INVENTION

According to a first general aspect, there is provided a data transmission system for an irrigation system. The data transmission system comprises at least one field sensor collecting field data and at least one field monitoring station in communications with the at least one field sensor. The field data collected using the at least one field sensor is transmitted to the at least one field monitoring station at a field data transmission interval adjusted according to a likelihood of an upcoming irrigation need determined based on the field data collected by the at least one field sensor.

In an embodiment, the data transmission system further comprises a control unit in communications with the at least one field monitoring station over a remote communications lin. The field data is transmitted from the at least one field monitoring station to the control unit at the field data transmission interval and the control unit generates irrigation instructions based on the field data.

In an embodiment, the data transmission system further comprises at least one irrigation control component in communications with the control unit through the at least one field monitoring station. The operation of the at least one irrigation control component is controlled by the at least one field monitoring station based on the irrigation instructions received from the control unit. The control unit performs at least one of emitting and receiving keep alive packets at a fixed time interval and the at least one field monitoring station performs at least the other one of emitting and receiving the keep alive packets at the fixed time interval to maintain the remote communications link open between the at least one field monitoring station and the control unit.

In an embodiment, the field data transmission interval is adjusted according to a result of a comparison between the field data collected by the at least one field sensor and at least one field data threshold.

In an embodiment, each one of the at least one field data threshold comprises a plurality of field data thresholds.

In an embodiment, each one of the at least one field data threshold includes at least one of an acceleration threshold and a deceleration threshold.

In an embodiment, the at least one field data threshold includes at least one of a soil temperature threshold, an air temperature threshold, an air humidity threshold, a soil salinity threshold, a soil tension threshold and a leaf wetness threshold.

According to another general aspect, there is also provided an automated irrigation system for automated irrigation of a field. The automated irrigation system comprises at least one field sensor configured to measure field data, at least one field monitoring station in communications with the at least one field sensor to receive the field data measured by the at least one field sensor. The at least one field monitoring station receives the field data from the at least one field sensor at a field data transmission interval adjusted based on the field data measured by the at least one field sensor. The automated irrigation system also comprises at least one irrigation control component selectively configurable in an irrigation configuration to irrigate at least partially the field and an inoperative configuration, based on the field data measured by the at least one field sensor.

In an embodiment, the automated irrigation system further comprises a control unit in communications with the at least one field monitoring station over a remote communications link. The field data is transmitted from the at least one field monitoring station to the control unit at the field data transmission interval. The control unit generates irrigation instructions based on the field data measured by the at least one field sensor.

In an embodiment, the control unit is in communications with the at least one irrigation control component to selectively configure the at least one irrigation control component in one of the irrigation configuration and the inoperative configuration using the irrigation instructions.

In an embodiment, the control unit includes a field control station.

In an embodiment, the at least one field monitoring station is in communications with the at least one irrigation control component, the at least one field monitoring station receiving the irrigations instructions from the control unit over the remote communications link to selectively configure the at least one irrigation control component in one of the irrigation configuration and the inoperative configuration.

In an embodiment, the control unit includes a control server. The control server performs at least one of emitting and receiving keep alive packets and the at least one field monitoring station performs at least the other one of emitting and receiving the keep alive packets, at a fixed time interval, to maintain the remote communications link open between the control server and the at least one field monitoring station.

In an embodiment, the field data transmission interval is selected based on a comparison between the field data measured by the at least one field sensor and at least one field data threshold.

According to another general aspect, there is also provided a method of performing data transmission for an irrigation system. The method comprises the steps of: collecting field data using at least one field sensor; transmitting the field data collected by the at least one field sensor to a corresponding field monitoring station; transmitting the field data received by the corresponding field monitoring station to a control unit over a remote communications link at a field data transmission interval; and adjusting the field data transmission interval according to a likelihood of an upcoming need of irrigation determined based on the field data collected by the at least one field sensor.

In an embodiment, the method further comprises the step of comparing the field data collected by the at least one field sensor with at least one field data threshold.

In an embodiment, the method further comprises the steps of: generating irrigation instructions by the control unit, based on the field data received from the at least one field monitoring station; and transmitting the irrigation instructions to the corresponding field monitoring station.

In an embodiment, the method further comprises the step of transmitting a keep alive packet from one of the corresponding field monitoring station and the control unit to the other one of the corresponding field monitoring station and the control unit at a fixed time interval, the keep alive packet being configured to maintain the remote communications link open therebetween.

According to another general aspect, there is further provided a data transmission system for an irrigation system. The data transmission system comprises: at least one field sensor collecting field data; at least one field monitoring station in communications with the at least one field sensor; and a control unit in communications with the at least one field monitoring station over a remote communications link. The field data collected using the at least one field sensor is transmitted to the at least one field monitoring station. The field data is transmitted from the at least one field monitoring station to the control unit at a field data transmission interval adjusted according to a likelihood of an upcoming irrigation need determined based on the field data collected by the at least one field sensor. The control unit generates irrigation instructions based on the field data.

In an embodiment, the data transmission system further comprises at least one irrigation control component in communications with the control unit through the at least one field monitoring station. The operation of the at least one irrigation control component is controlled by the at least one field monitoring station based on the irrigation instructions received from the control unit. The control unit performs at least one of emitting and receiving keep alive packets at a fixed time interval and the at least one field monitoring station performs at least the other one of emitting and receiving the keep alive packets at the fixed time interval to maintain the remote communications link open between the at least one field monitoring station and the control unit.

### BRIEF DESCRIPTION OF THE DRAWINGS

Other objects, advantages and features will become more apparent upon reading the following non-restrictive description of embodiments thereof, given for the purpose of exemplification only, with reference to the accompanying drawings in which:

FIG. 1 is a schematic representation of an automated irrigation system according to an embodiment where the irrigation system includes one field monitoring station and a control server.

FIG. 2 is a schematic representation of an automated irrigation system according to an embodiment where the irrigation system includes one field monitoring station and one field control station.

FIG. 3 is a graph showing a temperature variation over time and two temperature thresholds upon which a change in the field data transmission interval is triggered, according to an embodiment.

FIG. 4 is a schematic representation of a data transmission sequence between a field monitoring station and a control server of the irrigation system of FIG. 1, according to an embodiment.

### DETAILED DESCRIPTION

In the following description, the same numerical references refer to similar elements. The embodiments, geometrical configurations, materials mentioned and/or dimensions shown in the figures or described in the present description are embodiments only, given solely for exemplification purposes.

Moreover, although the embodiments of the automated irrigation system and corresponding parts thereof consist of certain configurations as explained and illustrated herein, not all of these components and configurations are essential and thus should not be taken in their restrictive sense. It is to be understood, as also apparent to a person skilled in the art, that other suitable components and cooperation thereinbetween, as well as other suitable configurations, can be used for the automated irrigation system, as will be briefly explained herein and as can be easily inferred herefrom by a person skilled in the art.

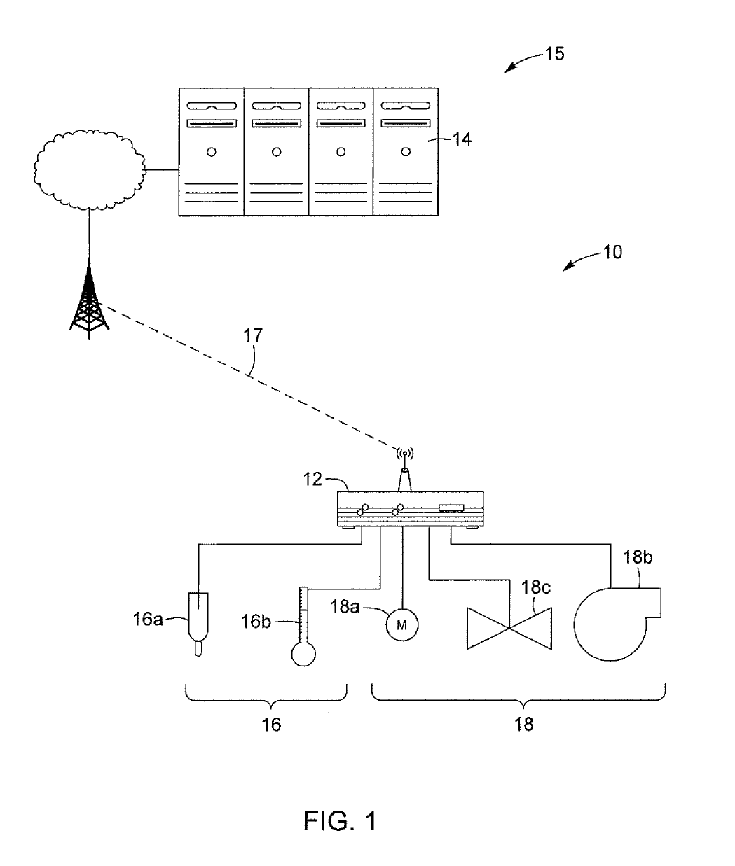

Referring generally to FIG. 1, in accordance with an embodiment, there is provided an automated irrigation system 10. In the embodiment of FIG. 1, the automated irrigation system 10 includes a control server 14 operating as control unit 15 and communicating with at least one field monitoring station 12. The at least one field monitoring station 12 is connected to at least one field sensor 16 configured to collect field data which can be interpreted in order to determine plant water needs and communicate the data to the corresponding field monitoring station 12. The at least one field monitoring station 12 is also connected to at least one irrigation control component 18 configured to control the supply of water to a corresponding section of a field which is irrigated using the automated irrigation system 10.

One skilled in the art will understand that, in an embodiment (not shown), the automated irrigation system 10 can include a plurality of field monitoring stations 12 rather than the single field monitoring station 12 as shown, each one of the plurality of field monitoring stations 12 communicating with same or different corresponding field sensors 16 and/or irrigation control components 18. The field monitoring stations 12 can be distributed over a geographic area, in order to cover the given land area to be irrigated using the automated irrigation system 10. In an embodiment such as the one shown in FIG. 1 but with a plurality of field monitoring stations 12, each one of the plurality of field monitoring stations 12 can be in communication with the control server 14.

In an embodiment, the field monitoring stations 12 do not communicate with one another. However, one skilled in the art will understand that, in an alternative embodiment, communications between field monitoring stations 12 can be allowed, for example, such that one of the field monitoring stations 12 acts as a relay between another field monitoring station 12 and the control unit 15.

It will be understood that for simplicity and clarity of the description, reference to a single field monitoring station 12 and the corresponding at least one field sensors 16 and at least one irrigation control component 18 will be made in the remaining of the present description. One skilled in the art will understand that the operation of each one of the field monitoring stations 12 of an irrigation system 10 including a plurality of field monitoring stations 12 would be similar to the operation of the field monitoring station 12 of an irrigation system 10 including a single field monitoring station 12, as described in more details below.

In the embodiment shown, the control server 14 acts as the central control unit 15 cooperating with the field monitoring station 12 in order to control the automated irrigation system 10, according to predetermined irrigation parameters selected by a user. In the course of the present description, the term “control unit” is used to refer to a device configured to receive and store data from the field sensors 16 as well as data relative to the irrigation parameters, to process the data and to generate irrigation instructions based on the processed data. The term “control server” is used to refer to a computer or computer system located away from the field to be monitored and/or irrigated and which is configured to receive and store the data from the field sensors 16 as well as data relative to the irrigation parameters, to process the data and to generate irrigation instructions based on the processed data. The control server 14 can be a stand-alone computer or a computer system which can be a centralized system or a distributed system, or the like.

In an embodiment (not shown), the irrigation parameters can be entered/updated by a user using a user interface displayed on a communications device. For example and without being limitative, in an embodiment, the user interface can be accessed by a user through a personal computer, a smartphone, a tablet, or the like, which allows the display of the user interface to the user and the input of data from the user. The communications device can be connected to the control server 14 over a communications network, such as, without being limitative, a local area network (LAN), a wireless local area network (WLAN) or a wide area network (WAN), wireless wide area network (WWAN), or the like. In an embodiment, the user interface also allows the display of data from the field sensors 16 to the user. Such data can be used by the user in the setting of the irrigation parameters or simply as an information source regarding field conditions. In an embodiment, alerts can be generated through the user interface when predetermined conditions are met and users can request initiation/termination of the irrigation process, for the entire field or a section thereof, directly from the user interface.

In an embodiment, the control server 14 is connected to the field monitoring stations 12 over a remote communications link or network such that data gathered from the field sensors 16 can be communicated from the field monitoring station 12 to the control server 14 and irrigation instructions can be communicated from the control server 14 to the field monitoring stations 12. One skilled in the art will understand that, once again, several types of communications links can be used for connecting the control server 14 and the field monitoring stations 12. In the embodiment shown, the control server 14 communicates with the field monitoring stations 12 over a cellular communications link 17. In an embodiment, the cellular communications link 17 can be part of a wireless wide area network (WWAN) to connect the control server 14 to the field monitoring stations 12. One skilled in the art will however understand that any relevant wireless communications protocol such as radio frequency (RF), Wi-Fi, or the like can be used. Moreover, it will be understood that, even though wireless communications are more adapted for the transmission of data between the field monitoring stations 12 located in the field and the remote control server 14, in an embodiment, wired connection or a combination of a wireless and a wired connection can be provided therebetween.

The field monitoring station 12 is a processing and communications unit configured to receive data from the field sensors 16 connected thereto, and to process and communicate the data to the control server 14. The field monitoring station 12 also receives instructions from the control server 14 and operates to issue control signals to the irrigation control components 18 in response to the irrigation instructions received from the control server 14. One skilled in the art will understand that, in an embodiment, the field monitoring station 12 can also be configured to receive, store and implement irrigation instructions and includes the logic to implement such irrigation instructions for example, by making determinations and issuing control signals to the irrigation control components 18 based on the received data from the field sensors 16, without explicit instructions from the control server 14, for time periods.

In an embodiment, the field monitoring station 12 includes a transceiver (not shown) configured to implement the relevant communications protocol used for communications with the control server 14 over the remote communications link. In an embodiment, the transceiver is a cellular modem for communications via the cellular communications link 17. In an embodiment, the field monitoring station 12 also includes field sensor ports (not shown) for connecting field sensors 16 thereto, and control element ports (not shown) for connecting the field monitoring station 12 to the control components 18, over a field communications link, for example, using a wired connection.

One skilled in the art will understand that, in an alternative embodiment, a converter can be connected to the field sensor port in order to allow communications between different types of field sensors 16 and the field monitoring station 12 through the field sensor ports. Moreover, it will be understood that, in another alternative embodiment, the field monitoring station 12 and the field sensors 16 and/or the control components 18 can also be configured such that the field communications link between the field monitoring station 12 and the field sensors 16 and/or the control components 18 is a wireless connection or a combination of a wired and a wireless connection.

The field sensors 16 are sensors configured to collect field data to be processed in order to define plant water needs and determine an irrigation schedule based on the irrigation parameters. For example and without being limitative, the field data can relate to soil tension, soil temperature, soil salinity, soil oxygen, air temperature, air humidity, leaf wetness, precipitation amount, solar radiation flux density, atmospherical pressure or the like. The field sensors 16 are located directly in the field or at an appropriate location in order to properly measure the desired parameter. For example and without being limitative, a field sensor 16 can be a tensiometer 16a having a probe located underground, in order to measure the tension of the soil onto which it is buried or a temperature sensor 16b measuring soil temperature and/or air temperature. One skilled in the art will understand that, in an alternative embodiment, any type of sensor providing relevant field data can be used. In an embodiment, a plurality of field sensors 16 providing field data relative to a combination of parameters which can be processed can be connected to a corresponding field monitoring station 12. In an alternative embodiment, only one field sensor 16 can be connected to a corresponding field monitoring station 12.

The irrigation control components 18 are components of the system 10 which can be operated to control the supply of water of one or more irrigation unit(s) or water distribution device(s), such as, without being limitative sprinklers, drip lines, or the like. For example and without being limitative, the irrigation control components 18 can be an electric motor 18a or a fuel engine 18b, such as a gasoline engine, a diesel engine or the like, of a corresponding water pump, a valve 18c, or other similar components, which can be activated/deactivated and or opened/closed in order to selectively configure the one or more irrigation unit(s) in an irrigation configuration wherein the one or more irrigation control component irrigates at least partially the field and an inoperative configuration to prevent irrigation. In other words, control signals are issued to the irrigation control components 18 to either initiate irrigation of a field section or to cease such irrigation. It will be understood that, in an embodiment, each field monitoring station 12 is connected to one or a plurality of irrigation control component(s) 18 in order to control the supply of water of one or more water distribution device(s) of a specific field section.

One skilled in the art would understand that, in an embodiment, a plurality of field monitoring stations 12, each connected to corresponding irrigation control components 18, can be connected in cascade, i.e. the state of the irrigation control components 18 associated with a first field monitoring station 12 can impact on the state of irrigation control components 18 connected to a second field monitoring station 12. For example and without being limitative, activation of a motor of a pump or opening of a valve connected to the first field monitoring station 12 can be required previously to the activation of a motor of a pump or opening of a valve connected to the second field monitoring station 12 and vice-versa.

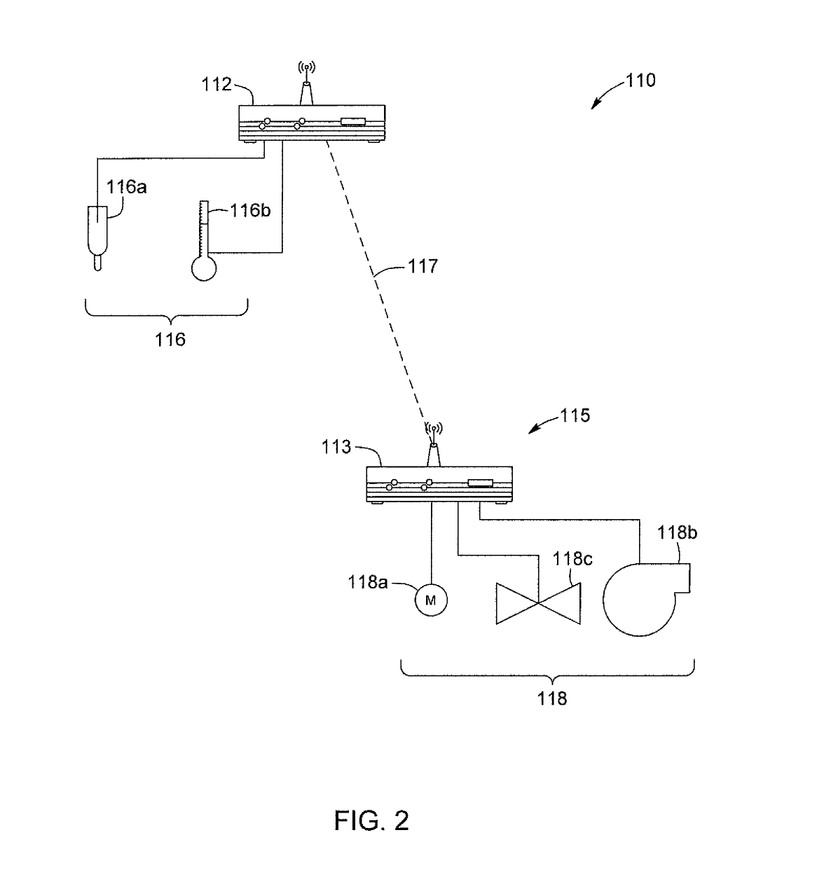

Referring generally to FIG. 2, there is shown an alternative embodiment of the automated irrigation system 10 wherein similar features are numbered using the same reference numerals in the 100 series. In the embodiment of FIG. 2, the automated irrigation system 110 includes a field control station 113 operating as control unit 115 and communicating with the at least one field monitoring station 112. Once again, the at least one field monitoring station 112 is connected to the at least one field sensor 116 configured to collect field data which can be interpreted in order to determine plant water needs and communicate the data to the corresponding field monitoring station 112. The field control station 113 is connected to the at least one irrigation control component 118 configured to control the supply of water to a corresponding section of a field which is irrigated using the automated irrigation system 110.

Once again, the automated irrigation system 110 can include a plurality of field monitoring stations 112 rather than the single field monitoring station as shown, but for simplicity and clarity of the description, reference to a single field monitoring station 112 and the corresponding field sensors 116 will be made in the description below. The same singularity with regards to the following description applies to the field control station 113 in communications with the field monitoring station(s) 112, i.e. in an alternative embodiment, more than one field control stations 113 can be connected to one or more field monitoring station(s) 112.

In the embodiment of FIG. 2, the field control station 113 acts as the central control unit 115 and cooperates with the field monitoring station 112 in order to control the automated irrigation system 110, according to predetermined irrigation parameters. The term “field control station” is used herein to define a controller located directly in the field to be monitored and/or irrigated and configured to receive and store data from the field sensors 116 as well as data relative to the irrigation parameters (for example, by a user through a user interface located directly on the field control station 113), to process the data and to generate irrigation instructions based on the processed data. The field control station 113 includes the logic to determine the irrigation instructions and generate and transmit control signals to the irrigation control components 118.

Similarly to the embodiment of FIG. 1, in the embodiment of FIG. 2, the field control station 113 is connected to the field monitoring station 112 over the remote communications link or network, such as a cellular communications link 117, to allow data gathered from the field sensors 116 to be communicated from the field monitoring station 112 to the control field control station 113.

One skilled in the art will understand that the field monitoring station 112, field sensors 116 and irrigation control components 118 include the same components and operate substantially similarly to the above description given with regards to FIG. 1. It will be understood that, in the embodiment of FIG. 2, the field control station 113 includes the appropriate communications components to allow communications between the field control station 113 and the irrigation control components 118 rather than between the field monitoring station 12 and the irrigation control components 18 as described in connection to FIG. 1.

Referring to FIGS. 1 and 2, in an embodiment, in order to limit power consumption of the field monitoring station 12, 112, intervals of transfer of functional data (i.e. field data collected using the field sensors 16, 116) can be varied according to variation in the field data collected by the field sensors 16, 116 which indicate a likelihood of an upcoming need of irrigation. Indeed, the time interval between the transmissions of field data between the field sensors 16, 116 and the field monitoring station 12, 112 and/or between the field monitoring station 12, 112 and the control unit 15, 115 (such as the control server 14 (FIG. 1) or the field control station 113 (FIG. 2)) can be increased when field data indicates that the likelihood of an upcoming need of irrigation is low and/or can be decreased when field data indicates that the likelihood of an upcoming need of irrigation is high.

In an embodiment, the field monitoring station 112 and/or the control unit 15, 115 are therefore configured to process field data collected by the field sensors 16, 116 and determine the likelihood of an upcoming need of irrigation based on predetermined thresholds for data collected by the different sensor types. For example and without being limitative, a decrease of the field data transmission interval can be performed when a salinity level of the soil is below a salinity acceleration threshold or when an air temperature is below an air temperature acceleration threshold or the like and/or an increase of the field data transmission interval can be performed when a salinity level of the soil is above a salinity deceleration threshold or when a temperature is above an air temperature deceleration threshold.

In the course of the present description, the term “acceleration threshold” is used to define a threshold value for a particular parameter of the field data collected by the field sensors 16, 116, from which the upcoming need of irrigation is determined to increase. Similarly, in the course of the present description, the term “deceleration threshold” is used to define a threshold value for a particular parameter of the field data collected by the field sensors 16, 116, from which the upcoming need of irrigation is determined to decrease. Both the “acceleration threshold” and the “deceleration threshold” can be a “lower” threshold, i.e. a threshold indicative that the upcoming need of irrigation increases/decreases if the value of the corresponding parameter, from the field data, is equal or below the threshold, or an “upper” threshold, i.e. a threshold indicative that the upcoming need of irrigation increases/decreases if the value of the corresponding parameter, from the field data, is equal or above the threshold.

It will be understood that, in an embodiment, a plurality of intermediary acceleration/deceleration thresholds for a particular parameter of the field data, such as temperature or the like, can be provided, i.e. more than one acceleration/deceleration threshold can be used for a specific parameter of the field data, with each intermediary acceleration/deceleration thresholds being associated to an increase/decrease in the field data transmission, when reached.

In view of the above, it will be understood that the field data transmission interval can be repeatedly adjusted based on trends detected in the parameters of the field data transmitted by the at least one field sensor 16, 116. For example and without being limitative, in such an embodiment, the field data transmission interval can be repeatedly increased/decreased when an increase or decrease is detected between consecutive field data collected by the at least one field sensor 16, 116, for one or more parameters. For example, the field data transmission interval can be repeatedly increased when an increase in soil tension is measured and repeatedly decreased when a decrease in soil tension is measured. Similarly, the field data transmission interval can be repeatedly decreased when a decreased in air temperature is measured and repeatedly increased when an increase in air temperature is measured.

In view of the above, for example and without being limitative, in an embodiment, the standard interval of field data transmission between the field sensors 16, 116, the field monitoring station 12, 112 and the control unit 15, 115 is every fifteen minutes. When the likelihood of an upcoming need of irrigation is determined to be low (i.e. when the one or more deceleration threshold is reached), the interval of field data transmission between the field sensors 16, 116, the field monitoring station 12, 112 and the control unit 15, 115 can be increased, for example and without being limitative, to thirty minutes. As mentioned above, intermediary decelerated intervals of field data transmission (i.e. interval slower than the standard interval of 15 minutes but faster than the decelerated interval of 30 minutes) can be used when intermediary deceleration thresholds are reached. When the likelihood of an upcoming need of irrigation is determined to be high (i.e. when the one or more acceleration threshold is reached), the interval of field data transmission can be decreased to, for example and without being limitative, one minute. Once again, intermediary accelerated intervals of field data transmission (i.e. interval faster than the standard interval of 15 minutes but slower than the accelerated interval of 1 minute) can be used when intermediary acceleration thresholds are reached. One skilled in the art will understand that such intervals of field data transmission are only indicative and can be varied in accordance to the particularity of each system 10, 110 and the conditions in which it is used.

In an embodiment, the interval of field data transmission is the same for all parameters of the field data, i.e. the transmission of every parameters measured using the field sensors 16, 116 between the field sensors 16, 116 and the field monitoring station 12, 112 and/or between the field monitoring station 12, 112 and the control unit 15, 115 occurs at the same variable interval. One skilled in the art will understand that, in an alternative, the interval of field data transmission can however be different for different parameters of the field data, i.e. different parameters measured using the field sensors 16, 116 can each have a specific data transmission interval between the field sensors 16, 116 and the field monitoring station 12, 112 and/or between the field monitoring station 12, 112 and the control unit 15, 115. In such an embodiment, the field data transmission interval between the field sensors 16, 116 and the field monitoring station 12, 112 and/or between the field monitoring station 12, 112 and the control unit 15, 115 is set to the interval associated with the parameter having the lowest data transmission interval, i.e. the field data transmission interval of the parameter requesting the most frequent data transmission is used.

In an embodiment, the field data transmission interval for a specific field data parameter collected from the at least one field sensor 16, 116 can be adjusted based on another field data parameter from the same at least field sensor 16, 116 or from another one of the at least one field sensor 16. For example and without being limitative, in an embodiment, the field data transmission interval of field data related to soil tension can be decreased when field data related to temperature is over a temperature acceleration threshold, for example over 40° Celsius. In an alternative embodiment, the field data transmission interval of field data related to soil oxygen can be increased when field data related to soil tension is below a soil tension deceleration threshold, or the like.

In an embodiment, the variations in field data transmission interval between the field sensors 16, 116 and the field monitoring station 12, 112 and the variations in field data transmission interval between the field monitoring station 12, 112 and the control unit 15, 115 are similar. One skilled in the art will however understand that, in an alternative embodiment, the variations in field data transmission interval between the field sensors 16, 116 and the field monitoring station 12, 112 and the variations in field data transmission interval between the field monitoring station 12, 112 and the control unit 15, 115 can be different.

In an embodiment (not shown) where a plurality of field monitoring stations 12, 112 are provided, the variations in time interval between the transmission of field data between the field sensors 16, 116 and the field monitoring station 12, 112 and/or between the field monitoring station 12, 112 and the control unit 15, 115 is similar for all the field monitoring stations 12, 112 of the system 10, 110. One skilled in the art will again understand that, in an alternative embodiment, the variations in time interval between the transmission of field data between the field sensors 16, 116 and the field monitoring station 12, 112 and/or between the field monitoring station 12, 112 and the control unit 15, 115 can be different for each of the field monitoring stations 12, 112 of the system 10, 110 or for subsets thereof.

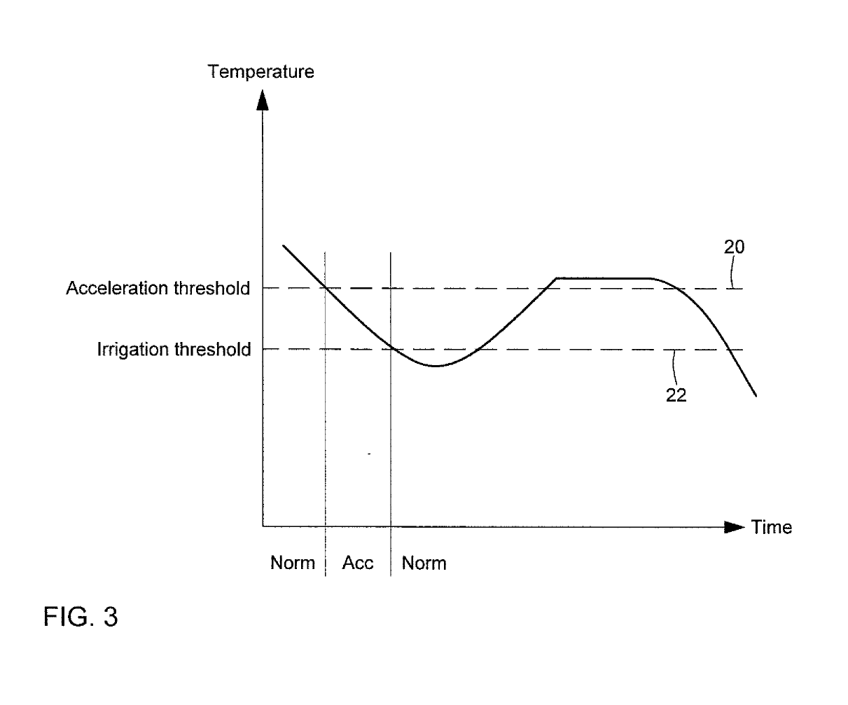

Now referring to FIG. 3, a graphical representation of an acceleration threshold 20 upon which a change in the field data transmission interval is triggered and an irrigation threshold 22 upon which irrigation is activated in order to provide frost protection is shown. As will be easily understood by one skilled in the art, the acceleration threshold 20 is a threshold indicative that irrigation can be required shortly for frost protection if the temperature further decreases and the irrigation threshold 22 is a threshold indicative that irrigation is required for frost protection.

The system 10, 110 therefore relatedly compares the data received from the temperature sensor 16b, 116b with the acceleration threshold 20 and the irrigation threshold 22 to adjust the field data transmission interval accordingly.

When the data received from the temperature sensor 16b, 116b indicates that the temperature has decreased below the acceleration threshold 20, the time interval between the transmission of data between the field sensors 16, 116 and the field monitoring station 12, 112 and/or between the field monitoring station 12, 112 and the control unit 15, 115 is decreased such that communications occur more frequently and further variation in the temperature can be communicated rapidly, in order for the system 10, 110 to react promptly.

If the temperature sensed by the temperature sensor 16b, 116b indicates that the temperature has further decreased and is below the irrigation threshold 22, irrigation instructions by the control unit 15, 115 can be generated promptly in order to initiate irrigation and provide frost protection, (i.e. prevent frost from negatively impacting on the crop production). During such period, the time interval between the transmission of field data between the field sensors 16, 116 and the field monitoring station 12, 112 and/or between the field monitoring station 12, 112 and the control unit 15, 115 can be increased to the standard time interval.

When the data received from the temperature sensor 16b, 116b indicates that the temperature has increased above the irrigation threshold 22, irrigation instructions can be generated by the control unit 15, 115 in order to terminate irrigation and the time interval between the transmission of field data between the field sensors 16, 116 and the field monitoring station 12, 112 and/or between the field monitoring station 12, 112 and the control unit 15, 115 is again decreased.

The above step sequence can be performed until the data received from the temperature sensor 16b, 116b indicates that the temperature has increased above the acceleration threshold 20 and the time interval between the transmission of field data between the field sensors 16, 116 and the field monitoring station 12, 112 and/or between the field monitoring station 12, 112 and the control unit 15, 115 can be increased to the standard time interval or any other suitable time interval.

One skilled in the art will understand that the above described variation in the field data transmission interval is not limited to frost protection. Therefore, in an alternative embodiment, several different thresholds for the variation in field data transmission interval between the field sensors 16, 116 and the field monitoring station 12, 112 and/or between the field monitoring station 12, 112 and the control unit 115 can be provided. Such thresholds can relate to any of the parameters sensed by the field sensors 16, 116 which are indicative of the likelihood of an upcoming need of irrigation, such as, for example, a soil temperature threshold, an air temperature threshold, a humidity threshold, a soil salinity threshold, a soil tension threshold and a leaf wetness threshold. As mentioned above, in an embodiment, where the variation in field data transmission is different for multiple parameters and thereby results in different field data transmission interval for each one of the parameters, the field data transmission interval can be set to the lowest field data transmission interval, i.e. the field data transmission interval which is the most frequent.

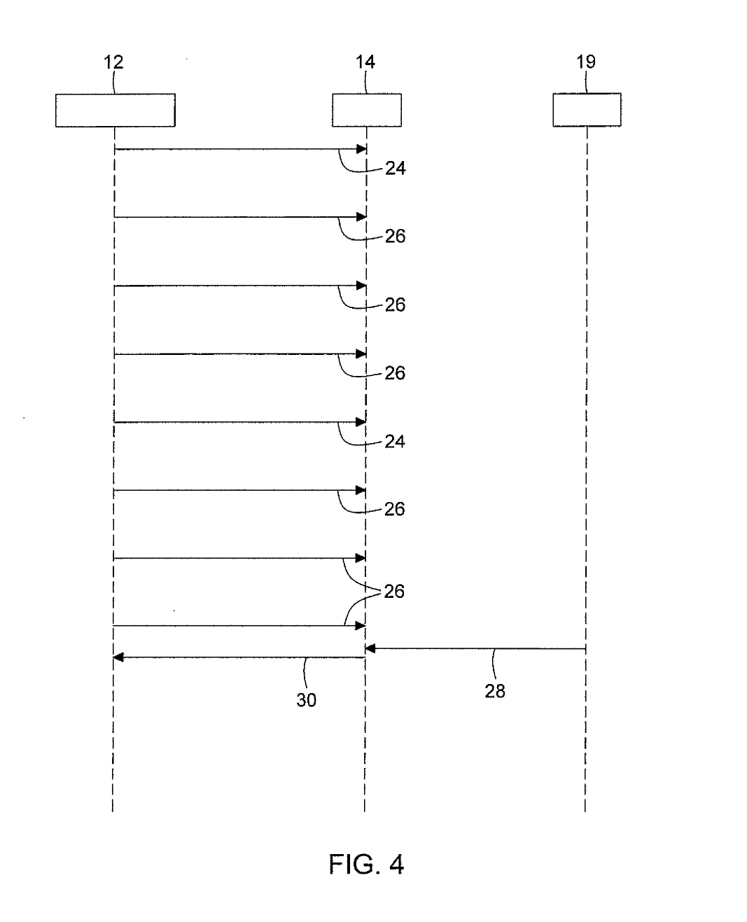

With reference to FIGS. 1 and 4, in an embodiment, the field monitoring station 12 is located directly in the field (or other remote location from the control unit 15) and is connected to a limited power source, such as, without being limitative, a solar panel, and therefore requires power consumption to be minimized. At the same time, in certain cases, it is desirable to maintain the remote communications link, such as the cellular link 17, between the field monitoring station 12 and the control unit 15 constantly open, for example, in order to minimize response time of the field monitoring station 12, upon generation of irrigation instructions from the control unit 15. In other words, it is desirable that no offline period occurs between the field monitoring station 12 and the control unit 15 as a result of modem disconnection or the like, because of a data transmission interval that is too long. Indeed, when the irrigation control components 18 are connected to the field monitoring station 12 and especially in cases where irrigation control components 18 are connected in cascade, it is desirable that irrigation instructions are transmitted to each field monitoring station 12 from the control unit 15 without delay, i.e. without having to wait a next connection cycle.

In an embodiment, in order to maintain the connection between the field monitoring station 12 and the control unit 15 constantly active, a small quantity of data, i.e. a keep alive packet, is emitted and transmitted from the field monitoring station 12 to the control unit 15 periodically, at fixed time intervals, such as, for example and without being limitative every minute. For example and without being limitative, in an embodiment, a keep alive packet can be transmitted from the field monitoring station 12 to the control unit 15 each minute in order to prevent the disconnection of the modem of the field monitoring station 12 from the remote communications link, such as the cellular link 17, between the control unit 15 to the field monitoring station 12. The keep alive packet does not contain functional data (i.e. data relevant to operation of the irrigation system), but rather is a small packet containing minimal information. For example and without being limitative, the keep alive packet can include a byte of data intended to prevent disconnection of the modem of the field monitoring station 12 (by preventing the network address translation of the cellular provider, or other network configuration, from reaching a timeout). One skilled in the art will understand that, the transmission of such small quantity of data requires minor amount of power from the field monitoring station 12 and therefore does not impact substantially on the overall power consumption of the field monitoring station 12.

In an embodiment, during specific time periods, the modem of the field monitoring station 12 can operate in a low power consumption mode where it is capable of detecting the presence of an incoming message without requiring a full power mode. One skilled in the art will understand that, in an embodiment, the fixed time intervals for the transmission of the keep alive packet from the field monitoring station 12 to the control unit 15, can differ from the above mentioned intervals of one minute, provided that the fixed time intervals are short enough for the connection not to reach a timeout and result in the loss of the communications between the control unit 15 to the field monitoring station 12. One skilled in the art will also understand that, in an embodiment, the keep alive packets could be emitted from the control unit 15 and transmitted to the field monitoring station 12 rather than from the field monitoring station 12 to the control unit 15, and still provide the desired maintenance of the communications link.

Referring to FIG. 4, a data transmission sequence between the field monitoring station 12 and the control server 14 of the irrigation system 10, according to an embodiment where the likelihood of an upcoming need of irrigation is determined to be neither high nor low, is shown. The field monitoring station 12 transmits field data 24 received from the field sensors 16 to the control server 14 at specific standard field data transmission intervals. In the embodiment shown the specific standard field data transmission interval is every 15 minutes, but one skilled in the art will understand that in an alternative embodiment, the standard field data transmission interval can be different. Between each transmission of field data received from the field sensors 16 from the field monitoring station 12 to the control server 14, keep alive packets 26 are sent from the field monitoring station 12 to the control server 14 at fixed intervals, shorter than the standard field data transmission interval, in order to maintain the remote communications link open therebetween. In the embodiment shown, a user 19 requests initiation 28 of irrigation by the system 10, using the above mentioned user interface. Therefore, in response to the user request 28, irrigation instructions 30 to initiate irrigation are sent from the control server 14 to the field monitoring station 12. Given that the communications link between the field monitoring station 12 and the control server 14 is kept open by the transmission of keep alive packets 26 at fixed time intervals, the irrigation instructions 30 can be transmitted instantly to the field monitoring station 12, without waiting for the next connection between the field monitoring station 12 and the control server 14, and the irrigation can be initiated promptly.

One skilled in the art will understand that, in an alternative embodiment (not shown), the irrigation instructions 30 can be generated and transmitted from the control server 14 to the field monitoring station 12 as a result of a determination of an irrigation need by the control server 14 rather than following a user request 28 as shown in FIG. 4. For example the irrigation need can be determined by the control server 14 when a comparison between the transmitted field data 24 and the one or more irrigation threshold is performed and indicates that an irrigation threshold has been reached.

One skilled in the art will understand that, in an alternative embodiment, a data transmission sequence similar to the one shown in FIG. 4, can be provided in an automated irrigation system 10, 110 including a control unit 15 different than a control server 14. For example and without being limitative, in an embodiment, the control unit 15, can be a control field control station 113 of an automated irrigation system 10, 110 as shown in FIG. 2.

Several alternative embodiments and examples have been described and illustrated herein. The embodiments of the invention described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. It is understood that the invention can be embodied in other specific forms without departing from the central characteristics thereof. The present examples and embodiments, therefore, are to be considered in all respects as illustrative and not restrictive, and the invention is not to be limited to the details given herein. Accordingly, while specific embodiments have been illustrated and described, numerous modifications come to mind without significantly departing from the scope of the invention as defined in the appended claims.

1. A data transmission system for an irrigation system, the data transmission system comprising:
at least one field sensor collecting field data; and
at least one field monitoring station in communications with the at least one field sensor, the field data collected using the at least one field sensor being transmitted to the at least one field monitoring station at a field data transmission interval adjusted according to a likelihood of an upcoming irrigation need determined based on the field data collected by the at least one field sensor.

2. The data transmission system of claim 1, further comprising a control unit in communications with the at least one field monitoring station over a remote communications link, the field data being transmitted from the at least one field monitoring station to the control unit at the field data transmission interval and the control unit generating irrigation instructions based on the field data.

3. The data transmission system of claim 2, the data transmission system further comprises at least one irrigation control component in communications with the control unit through the at least one field monitoring station, the operation of the at least one irrigation control component being controlled by the at least one field monitoring station based on the irrigation instructions received from the control unit, and wherein the control unit performs at least one of emitting and receiving keep alive packets at a fixed time interval and the at least one field monitoring station performs at least the other one of emitting and receiving the keep alive packets at the fixed time interval to maintain the remote communications link open between the at least one field monitoring station and the control unit.

4. The data transmission system of claim 1, wherein the field data transmission interval is adjusted according to a result of a comparison between the field data collected by the at least one field sensor and at least one field data threshold.

5. The data transmission system of claim 4, wherein each one of the at least one field data threshold comprises a plurality of field data thresholds.

6. The data transmission system of claim 4, wherein each one of the at least one field data threshold includes at least one of an acceleration threshold and a deceleration threshold.

7. The data transmission system of claim 4, wherein the at least one field data threshold includes at least one of a soil temperature threshold, an air temperature threshold, an air humidity threshold, a soil salinity threshold, a soil tension threshold and a leaf wetness threshold.

8. An automated irrigation system for automated irrigation of a field, the automated irrigation system comprising:
at least one field sensor configured to measure field data;
at least one field monitoring station in communications with the at least one field sensor to receive the field data measured by the at least one field sensor, the at least one field monitoring station receiving the field data from the at least one field sensor at a field data transmission interval; the field data transmission interval being adjusted based on the field data measured by the at least one field sensor; and
at least one irrigation control component selectively configurable in an irrigation configuration to irrigate at least partially the field and an inoperative configuration, based on the field data measured by the at least one field sensor.

9. The automated irrigation system of claim 8, further comprising a control unit in communications with the at least one field monitoring station over a remote communications link, the field data being transmitted from the at least one field monitoring station to the control unit at the field data transmission interval, the control unit generating irrigation instructions based on the field data measured by the at least one field sensor.

10. The automated irrigation system of claim 9, wherein the control unit is in communications with the at least one irrigation control component to selectively configure the at least one irrigation control component in one of the irrigation configuration and the inoperative configuration using the irrigation instructions.

11. The automated irrigation system of claim 10, wherein the control unit includes a field control station.

12. The automated irrigation system of claim 9, wherein the at least one field monitoring station is in communications with the at least one irrigation control component, the at least one field monitoring station receiving the irrigations instructions from the control unit over the remote communications link to selectively configure the at least one irrigation control component in one of the irrigation configuration and the inoperative configuration.

13. The automated irrigation system of claim 12, wherein the control unit includes a control server.

14. The automated irrigation system of claim 13, wherein the control server performs at least one of emitting and receiving keep alive packets and wherein the at least one field monitoring station performs at least the other one of emitting and receiving the keep alive packets, at a fixed time interval, to maintain the remote communications link open between the control server and the at least one field monitoring station.

15. The automated irrigation system of claim 8, wherein the field data transmission interval is selected based on a comparison between the field data measured by the at least one field sensor and at least one field data threshold.

16. A method of performing data transmission for an irrigation system, the method comprising:
collecting field data using at least one field sensor;
transmitting the field data collected by the at least one field sensor to a corresponding field monitoring station;
transmitting the field data received by the corresponding field monitoring station to a control unit over a remote communications link at a field data transmission interval; and
adjusting the field data transmission interval according to a likelihood of an upcoming need of irrigation determined based on the field data collected by the at least one field sensor.

17. The method of claim 16, further comprising comparing the field data collected by the at least one field sensor with at least one field data threshold.

18. The method of claim 16, further comprising:
generating irrigation instructions by the control unit, based on the field data received from the at least one field monitoring station; and
transmitting the irrigation instructions to the corresponding field monitoring station.

19. The method of claim 18, further comprising transmitting a keep alive packet from one of the corresponding field monitoring station and the control unit to the other one of the corresponding field monitoring station and the control unit at a fixed time interval, the keep alive packet being configured to maintain the remote communications link open therebetween.

20. A data transmission system for an irrigation system, the data transmission system comprising:
at least one field sensor collecting field data; and
at least one field monitoring station in communications with the at least one field sensor, the field data collected using the at least one field sensor being transmitted to the at least one field monitoring station; and
a control unit in communications with the at least one field monitoring station over a remote communications link, the field data being transmitted from the at least one field monitoring station to the control unit at a field data transmission interval adjusted according to a likelihood of an upcoming irrigation need determined based on the field data collected by the at least one field sensor, the control unit generating irrigation instructions based on the field data.

21. The data transmission system of claim 20, further comprising at least one irrigation control component in communications with the control unit through the at least one field monitoring station, the operation of the at least one irrigation control component being controlled by the at least one field monitoring station based on the irrigation instructions received from the control unit, and wherein the control unit performs at least one of emitting and receiving keep alive packets at a fixed time interval and the at least one field monitoring station performs at least the other one of emitting and receiving the keep alive packets at the fixed time interval to maintain the remote communications link open between the at least one field monitoring station and the control unit.

22. The data transmission system of claim 20, wherein the field data transmission interval is adjusted according to a result of a comparison between the field data collected by the at least one field sensor and at least one field data threshold.

23. The data transmission system of claim 22, wherein each one of the at least one field data threshold comprises a plurality of field data thresholds.

24. The data transmission system of claim 22, wherein each one of the at least one field data threshold includes at least one of an acceleration threshold and a deceleration threshold.
